(19) United States
(12) Patent Application Publication
(10) Pub. No.: US 2026/0312250 A1
(43) Pub. Date: Oct. 8, 2026

(54) ELECTRODE ASSEMBLY AND BATTERY

(71) Applicant: NINGDE AMPEREX TECHNOLOGY LIMITED, Ningde City (CN)

(72) Inventors: Jiao Tian, Ningde City (CN); Yujiang Xu, Ningde City (CN); Qiao Zeng, Ningde City (CN)

(73) Assignee: NINGDE AMPEREX TECHNOLOGY LIMITED, Ningde City (CN)

(21) Appl. No.: 19/712,547

(22) Filed: Jun. 18, 2026

Related U.S. Application Data
(63) Continuation of application No. 17/794,940, filed on Jan. 20, 2020.

(51) Int. Cl. H01M 50/534; H01M 10/04

(52) U.S. Cl. CPC H01M 50/534; H01M 10/0459

(57) ABSTRACT

An electrode assembly includes a first electrode plate, a second electrode plate, and a separator. The separator is positioned between the first electrode plate and the second electrode plate. A first electrode plate and a second electrode plate are stacked. The electrode assembly further includes a first tab positioned on the first electrode plate, and a second tab and a third tab that are positioned on the second electrode plate. Projections of the first tab, the second tab, and the third tab on the first electrode plate do not overlap. The electrode assembly is provided with a multi-tab structure to achieve purposes of enhancing a current-carrying capacity of the battery and reducing a temperature rise. This application further provides a battery containing the electrode assembly.

### CROSS-REFERENCE TO RELATED APPLICATIONS

This application is a continuation application of U.S application No. US17/794940, filed on Jul. 22, 2022, which is a national phase entry of International Application No. PCT/CN2020/073334, filed on Jan. 20, 2020, the contents of which are incorporated herein by reference in their entireties.

### TECHNICAL FIELD

The present application relates to the field of batteries, and in particular, to an electrode assembly and a battery that contains the electrode assembly.

### BACKGROUND

The application of 5G is accompanied with higher requirements imposed by consumers on battery performance of a portable electronic product such as a smart phone and a tablet computer. Existing batteries have the problem of a high temperature rise in both the battery and the integrated electronic product, and the performance of the battery and the electronic product may deteriorate if the temperature rise is too high. The existing battery adopts a two-tab structure, which does not improve an overall current-carrying capacity of the battery, and therefore, the temperature rise of the battery and the integrated electronic product is still relatively high.

### SUMMARY

In view of the foregoing situation, it is necessary to provide an electrode assembly capable of increasing a current-carrying capacity of a battery and reducing a temperature rise, and to provide a battery containing the electrode assembly.

An embodiment of this application discloses an electrode assembly, including a first electrode plate, a second electrode plate, and a separator. A polarity of the second electrode plate is opposite to a polarity of the first electrode plate, and the separator is positioned between the first electrode plate and the second electrode plate. A first electrode plate and a second electrode plate are stacked to form the electrode assembly. The electrode assembly further includes a first tab, a second tab, and a third tab. The first tab is positioned on the first electrode plate, and the second tab and the third tab are positioned on the second electrode plate. In a thickness direction of the electrode assembly, a projection of the first tab, a projection of the second tab, and a projection of the third tab on the first electrode plate do not overlap. The three tabs may be configured as two positive tabs and one negative tab, or two negative tabs and one positive tab. The plurality of tabs are connected in parallel to shunt a current to reduce a temperature rise of the electrode assembly.

In an optional embodiment, the second electrode plate includes a first electrode plate unit and a second electrode plate unit, the first electrode plate is positioned between the first electrode plate unit and the second electrode plate unit. The second tab is positioned on the first electrode plate unit, and the third tab is positioned on the second electrode plate unit.

In an optional embodiment, the second tab and the third tab are positioned on an identical first electrode plate unit or an identical second electrode plate unit.

Furthermore, in the thickness direction of the electrode assembly, a projection of the first tab on the first electrode plate is located between a projection of the second tab on the first electrode plate and a projection of the third tab on the first electrode plate.

In an optional embodiment, in a length direction of the electrode assembly, the second tab extends out of a first end of the electrode assembly, and the third tab extends out of a second end of the electrode assembly.

In an optional embodiment, the first tab includes a plurality of first tab units. The electrode assembly includes a plurality of the first electrode plates. The plurality of first tab units are positioned on the plurality of first electrode plates respectively. The plurality of first tab units are stacked in the thickness direction of the electrode assembly to form the first tab.

Furthermore, a fastener is positioned between the plurality of first tab units, and the fastener is configured to connect the plurality of first tab units to form the first tab.

In an optional embodiment, each of the first tab units and each of the first electrode plates are integrally formed.

In an optional embodiment, in the thickness direction of the electrode assembly, a projection of a first tab unit positioned on an n^{th} first electrode plate and projected on the first electrode plate overlaps that of a first tab unit positioned on an (n+2)^{th} first electrode plate. This increases a spacing between adjacent first tab units and improves heat dissipation performance of the first tab.

In an optional embodiment, at least two electrical connection portions are positioned at an end of the first tab, wherein the end of the first tab extends out of the electrode assembly. The at least two electrical connection portions are interspaced and configured to connect an external circuit. In this way, the first tab is divided into two tabs of identical polarity, thereby further shunting a current and increasing a current-carrying capacity of the electrode assembly.

In an optional embodiment, the electrode assembly further includes a fourth tab. The fourth tab is positioned on the first electrode plate or the second electrode plate, and, in the thickness direction of the electrode assembly, a projection of the fourth tab on the first electrode plate does not overlap the projections of the first tab, the second tab, and the third tab on the first electrode plate.

In an optional embodiment, in a length direction of the electrode assembly, the first tab extends out of a first end of the electrode assembly, and the second tab and the third tab extend out of a second end of the electrode assembly.

In an optional embodiment, a surface of the first tab or a surface of the third tab is plated with a metal material capable of being soldered and/or brazed, so as to enhance performance of the tabs including a current-carrying capacity.

In an optional embodiment, the metal material capable of being soldered and/or brazed is nickel.

In an optional embodiment, a material of the first tab or the third tab may be selected from copper, nickel, or nickel-plated copper.

An embodiment of this application further discloses a battery. The battery includes a package and any of the electrode assemblies described above. The electrode assembly is positioned in the package. The first tab, the second tab, and the third tab extend out of the package.

Furthermore, the battery includes a connecting piece. The connecting piece is positioned on an outer surface of the electrode assembly and configured to connect the package and the electrode assembly.

In the electrode assembly, the first tab, the second tab, and the third tab are positioned. Therefore, the electrode assembly exhibits a multi-tab structure, and shunts the current by using a plurality of parallel-connected tabs, thereby enhancing the current-carrying capacity of the battery and reducing the temperature rise.

### BRIEF DESCRIPTION OF DRAWINGS

FIG. 1 is a schematic diagram of an exterior structure of an electrode assembly according to a first embodiment;

FIG. 2 is a schematic structural diagram of a first electrode plate and a second electrode plate of the electrode assembly shown in FIG. 1;

FIG. 3 is a schematic diagram of an expanded structure of the electrode assembly shown in FIG. 1;

FIG. 4 is a schematic diagram of a laminated structure of the electrode assembly shown in FIG. 1;

FIG. 5 is a schematic structural diagram of a first electrode plate and a second electrode plate according to a second embodiment;

FIG. 6 is a schematic diagram of an expanded structure of an electrode assembly according to a second embodiment;

FIG. 7 is a schematic diagram of an exterior structure of an electrode assembly according to a third embodiment;

FIG. 8 is a schematic structural diagram of a first tab and a second tab of the electrode assembly shown in FIG. 7 according to a third embodiment;

FIG. 9 is a schematic diagram of an expanded structure of the electrode assembly shown in FIG. 7 according to a third embodiment;

FIG. 10 is a schematic structural diagram of a first electrode plate and a second electrode plate according to a fourth embodiment;

FIG. 11 is a schematic diagram of an exterior structure of an electrode assembly according to a fifth embodiment;

FIG. 12 is a schematic structural diagram of a first electrode plate and a second electrode plate of the electrode assembly shown in FIG. 11 according to a fifth embodiment;

FIG. 13 is a schematic diagram of an expanded structure of the electrode assembly shown in FIG. 11 according to a fifth embodiment;

FIG. 14 is a schematic diagram of an exterior structure of an electrode assembly according to a sixth embodiment;

FIG. 15 is a schematic diagram of a laminated structure of an electrode assembly according to a seventh embodiment;

FIG. 16 is a schematic diagram of a laminated structure of an electrode assembly according to an eighth embodiment; and

FIG. 17 is a schematic structural diagram of a battery according to a ninth embodiment.

### REFERENCE NUMERALS

Electrode assembly 100

First end 101

Second end 102

Seal 103

First electrode plate 10

Second electrode plate 20

First electrode plate unit 21

Second electrode plate unit 22

First side 23

Second side 24

Separator 30

First tab 40

First tab unit 41

Electrical connection portion 42

Second tab 50

Third tab 60

Fourth tab 70

Battery 200

Package 201

Connecting piece 202

### DETAILED DESCRIPTION OF EMBODIMENTS

The following clearly and fully describes the technical solutions in the embodiments of this application with reference to the drawings hereof. Apparently, the described embodiments are merely a part of but not all of the embodiments of this application. All other embodiments derived by a person of ordinary skill in the art based on the embodiments of this application without making any creative efforts shall fall within the protection scope of this application.

It needs to be noted that an element referred to as being "fixed to" another element may directly exist on the other element or may be fixed to the other element through an intermediate element. An element considered to be "connected to" another element may be directly connected to the other element or may be connected to the other element through an intermediate element. An element considered to be "positioned on" another element may be directly positioned on the other element or may be positioned on the other element through an intermediate element. The terms "vertical", "horizontal", "left", "right" and similar expressions used herein are merely for ease of description.

Unless otherwise defined, all technical and scientific terms used herein have the same meanings as usually understood by a person skilled in the technical field of this application. The terms used in the specification of this application herein are merely intended for describing specific embodiments but are not intended to limit this application. The term "and/or" used herein is intended to include any and all combinations of one or more related items preceding and following the term.

An embodiment of this application discloses an electrode assembly, including a first electrode plate, a second electrode plate, and a separator. A polarity of the second electrode plate is opposite to a polarity of the first electrode plate, and the separator is positioned between the first electrode plate and the second electrode plate. A plurality of the first electrode plates and a plurality of the second electrode plates are stacked to form the electrode assembly. The electrode assembly further includes a first tab, a second tab, and a third tab. The first tab is positioned on the first electrode plate, and the second tab and the third tab are positioned on the second electrode plate. In a thickness direction of the electrode assembly, projections of the first tab, the second tab, and the third tab on the first electrode plate do not overlap.

In the electrode assembly, the first tab, the second tab, and the third tab are positioned. Therefore, the electrode assembly exhibits a multi-tab structure, and shunts the current by using a plurality of parallel-connected tabs, thereby enhancing a current-carrying capacity of the battery and reducing a temperature rise.

The following describes some embodiments of this application in detail. To the extent that no conflict occurs, the following embodiments and the features in the embodiments may be combined with each other.

### First Embodiment

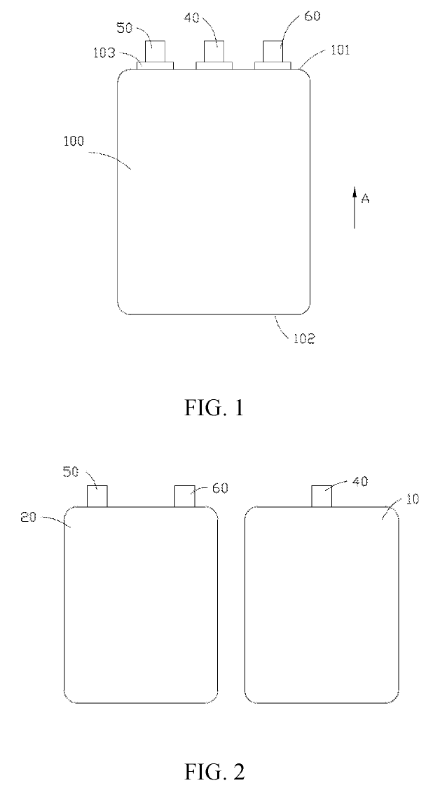

Referring to FIGS. 1 and 2, an electrode assembly 100 includes a first electrode plate 10, a second electrode plate 20, and a separator 30. A polarity of the second electrode plate 20 is opposite to a polarity of the first electrode plate 10, and the separator 30 is positioned between the first electrode plate 10 and the second electrode plate 20. A plurality of the first electrode plates 10 and a plurality of the second electrode plates 20 are stacked to form the electrode assembly 100. The electrode assembly 100 further includes a first tab 40, a second tab 50, and a third tab 60. The first tab 40 is positioned on the first electrode plate 10, and the second tab 50 and the third tab 60 are positioned on the second electrode plate 20. In a thickness direction of the electrode assembly 100, projections of the first tab 40, the second tab 50, and the third tab 60 on the first electrode plate 10 do not overlap. The three tabs may be configured as two positive tabs and one negative tab, or two negative tabs and one positive tab. The plurality of tabs are connected in parallel to shunt a current to reduce a temperature rise of the electrode assembly 100. According to an embodiment of this application, a material of the negative tab may be selected from copper, nickel, or nickel-plated copper.

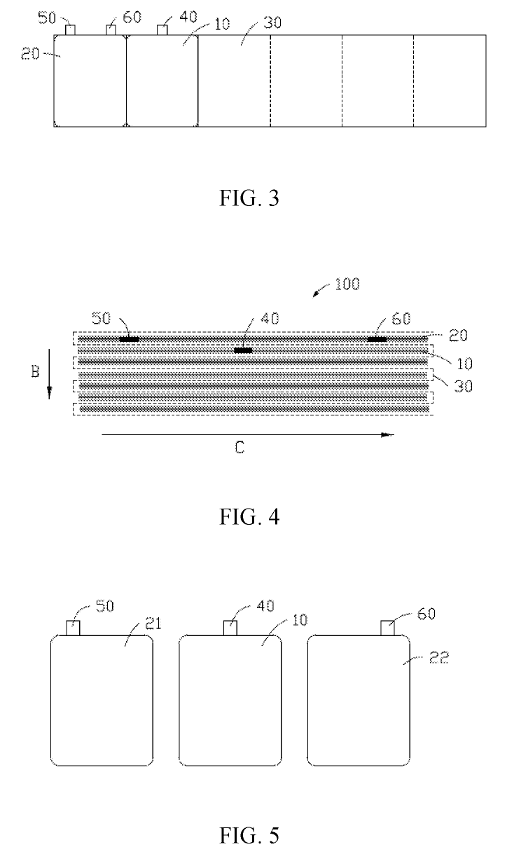

Referring to FIGS. 3 and 4, when the electrode assembly 100 is expanded, a plurality of first electrode plates 10 and a plurality of second electrode plates 20 are alternately positioned on the separator 30. The first tab 40 is positioned on one of the first electrode plates 10, and the second tab 50 and the third tab 60 are positioned on an identical second electrode plate 20. The separator 30 is folded in a Z shape or stacked so that a plurality of first electrode plates 10 and a plurality of second electrode plates 20 are stacked, and so that the separator 30 is positioned between the first electrode plate 10 and the second electrode plate 20. FIG. 3 shows a first electrode plate 10 and a second electrode plate 20 as an example. Other first electrode plates 10 and second electrode plates 20 positioned on the separator 30 are omitted in FIG. 3. The plurality of first electrode plates 10 are electrically connected, and the plurality of second electrode plates 20 are also electrically connected. The first electrode plates 10 are insulated from the second electrode plates 20 by the separator 30.

A direction indicated by an arrow A in FIG. 1 is a length direction of the electrode assembly 100, and a direction indicated by an arrow B in FIG. 4 is a thickness direction of the electrode assembly 100. In the first embodiment, the first tab 40, the second tab 50, and the third tab 60 are all extend out of an identical end of the electrode assembly 100 in the length direction. In the thickness direction of the electrode assembly 100, a projection of the first tab 40 on the first electrode plate 10 is located between a projection of the second tab 50 on the first electrode plate 10 and a projection of the third tab 60 on the first electrode plate. Understandably, in other embodiments, the projection of the second tab 50 on the first electrode plate 10 may be located between the projection of the first tab 40 and the projection of the third tab 60, or the projection of the third tab 60 on the first electrode plate 10 may be located between the projection of the first tab 40 and the projection of the second tab 50. This application is not limited thereto.

Furthermore, the electrode assembly 100 further includes a seal 103. The seal 103 is positioned at a junction between the tab and the electrode plate. This increases strength of the tab and prevents the tab from fracturing, and is also conducive to subsequent packaging of the electrode assembly 100. To avoid a short circuit, a spacing between adjacent seals 103 is at least 1 mm. The seal 103 may be selected from sealant, double-sided adhesive tape, hot-melt adhesive, and the like.

Furthermore, a surface of the first tab 40 is plated with a metal material capable of being soldered and/or brazed, so as to enhance performance of the tab including a current-carrying capacity, and facilitate welding between the first tab 40 and an external circuit. In this embodiment of this application, the metal material capable of being soldered and/or brazed is preferably a nickel metal material, and a structure of the first tab 40 is preferably a nickel-plated copper structure.

### Second Embodiment

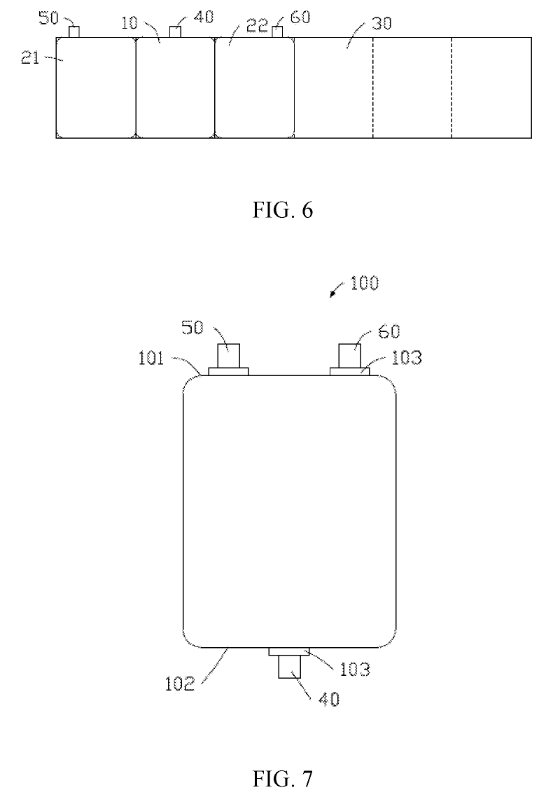

Referring to FIGS. 5 and 6, an electrode assembly 100 in a second embodiment is almost identical to that in the first embodiment, but differs in: in the second embodiment, the plurality of second electrode plates 20 each include a first electrode plate unit 21 and a second electrode plate unit 22. The second tab 50 is positioned on the first electrode plate unit 21, and the third tab 60 is positioned on the second electrode plate unit 22. In other words, the second tab 50 and the third tab 60 are positioned on different second electrode plates 20 respectively, thereby helping improve manufacturability of the electrode assembly 100 and being suitable for an electrode assembly 100 whose width is relatively small. A direction indicated by an arrow C in FIG. 4 is a width direction of the electrode assembly 100.

The first electrode plate unit 21, the first electrode plate 10, and the second electrode plate unit 22 are stacked. In the thickness direction of the electrode assembly 100, the projection of the first tab 40 on the first electrode plate 10 is still located between the projection of the second tab 50 on the first electrode plate 10 and the projection of the third tab 60 on the first electrode plate. Other structures of the electrode assembly 100 in the second embodiment are almost identical to those in the first embodiment, and are omitted herein.

### Third Embodiment

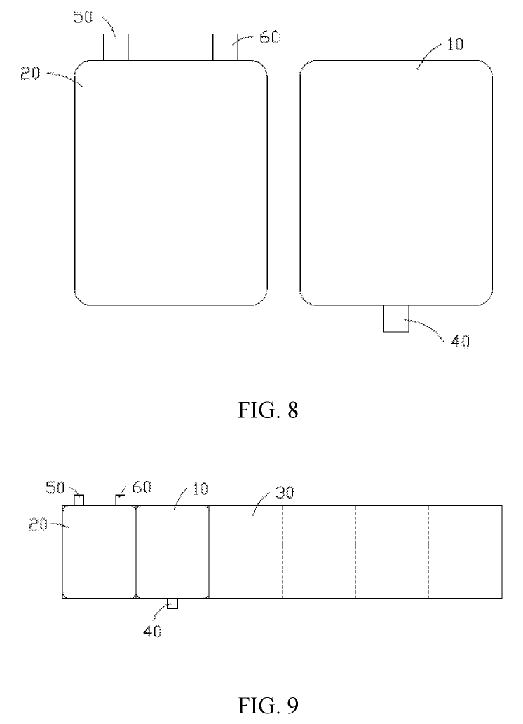

Referring to FIGS. 7, 8 and 9, an electrode assembly 100 in a third embodiment is almost identical to that in the first embodiment, but differs in: in the third embodiment, in a length direction of the electrode assembly 100, the first tab 40 extends out of a first end 101 of the electrode assembly 100, and the second tab 50 and the third tab 60 extend out of a second end 102 of the electrode assembly 100. The second tab 50 and the third tab 60 may be positioned on an identical second electrode plate 20 or positioned on different second electrode plates 20. This application is not limited thereto.

From a perspective of FIGS. 3 and 9, the first electrode plate 10 in the first embodiment may be rotated horizontally by 180° to obtain a laminated structure disclosed in the third embodiment. A manner of disposing the tab in the third embodiment is suitable for an electrode assembly 100 whose width is relatively small, and avoids interference between the projections of the first tab 40, the second tab 50, and the third tab 60 on the first electrode plate 10 but is not conducive to a subsequent process of bending the tab.

### Fourth Embodiment

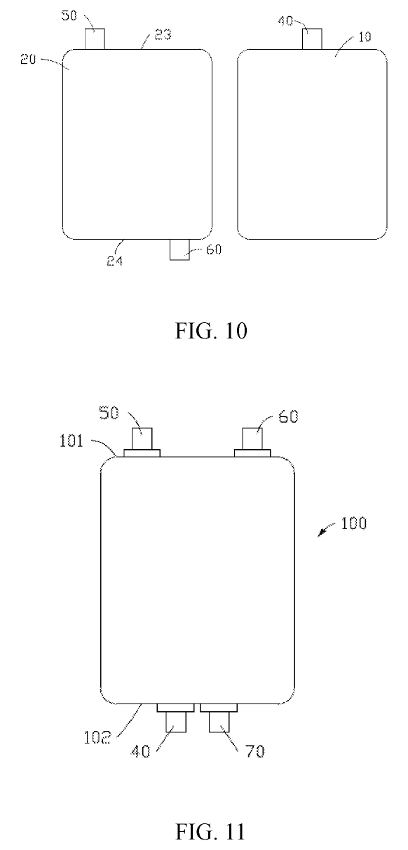

Referring to FIG. 10, an electrode assembly 100 in a fourth embodiment is almost identical to that in the first embodiment, but differs in: in the fourth embodiment, in a length direction of the electrode assembly 100, the second tab extends out of a first end 101 of the electrode assembly 100, and the third tab 60 extends out of a second end 102 of the electrode assembly 100.

In the fourth embodiment, both the second tab 50 and the third tab 60 are positioned on an identical second electrode plate 20. Along the length direction of the electrode assembly 100, the second tab is positioned on a first side 23 of the second electrode plate 20, and the third tab 60 is positioned on a second side 24 of the second electrode plate 20. In this way, after a stacking process is completed, the second tab 50 and the third tab 60 extend out of different ends of the electrode assembly 100 respectively.

Understandably, in other embodiments, the second tab 50 and the third tab 60 may also be positioned on different second electrode plates 20 to simplify manufacturing of the electrode assembly 100.

### Fifth Embodiment

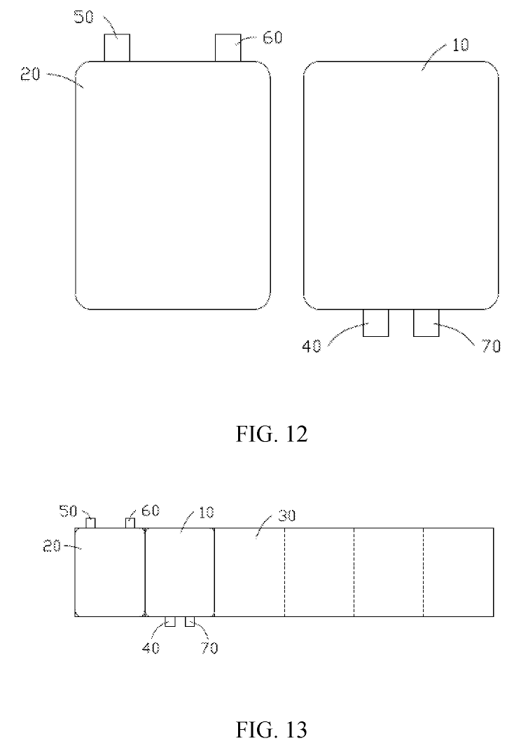

Referring to FIGS. 11, 12, and 13, an electrode assembly 100 in a fifth embodiment is almost identical to that in the third embodiment, but differs in: in the fifth embodiment, the electrode assembly 100 further includes a fourth tab 70. The fourth tab 70 is positioned on the first electrode plate 10 or the second electrode plate 20. In the thickness direction of the electrode assembly 100, a projection of the fourth tab 70 on the first electrode plate 10 does overlap the projections of the first tab 40, the second tab 50, and the third tab 60 on the first electrode plate 10. FIGS. 12 and 13 use an example in which the fourth tab 70 is positioned on the first electrode plate 10. In other embodiments, the fourth tab 70 and the first tab 40 may extend out of different ends of the electrode assembly 100 respectively. This application is not limited thereto.

### Sixth Embodiment

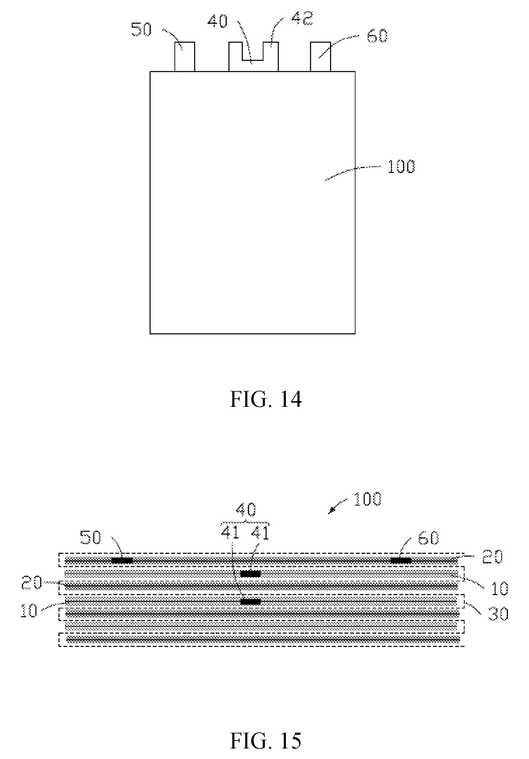

Referring to FIG. 14, an electrode assembly 100 in a sixth embodiment is almost identical to that in the first embodiment, but differs in: at least two electrical connection portions 42 are positioned at an end at which the first tab 40 extends out of the electrode assembly 100. The at least two electrical connection portions 42 are interspaced and configured to connect an external circuit. In this way, the first tab 40 is divided into two tabs of identical polarity, thereby further shunting the current and increasing the current-carrying capacity of the electrode assembly 100. The electrical connection portions 42 may be formed by welding a tab adapter onto the first tab 40, or may be formed by cutting the first tab 40. Understandably, in other embodiments, a quantity of the electrical connection portions 42 may be more than two, and this application is not limited thereto. By analogy, a plurality of electrical connection portions may also be positioned on the second tab 50 and the third tab 60.

### Seventh Embodiment

Referring to FIG. 15, an electrode assembly 100 in a seventh embodiment is almost identical to that in the first embodiment, but differs in: in the seventh embodiment, the first tab 40 includes a plurality of first tab units 41, and the plurality of first tab units 41 are positioned on the plurality of first electrode plates 10 respectively. In the thickness direction of the electrode assembly 100, the plurality of first tab units 41 are stacked to form the first tab 40.

Furthermore, a fastener is positioned between the plurality of first tab units 41, and the fastener is configured to connect the plurality of first tab units 41 to form the first tab. The fastener may be made of adhesive materials such as double-sided adhesive tape and hot-melt adhesive.

Each of the first tab units 41 and each of the first electrode plates 10 are integrally formed. Specifically, each first electrode plate 10 containing the first tab units 41 may be formed by cutting a raw material of the first electrode plate 10. In other embodiments, the first tab units 41 may be positioned on the first electrode plate 10 by welding. This application is not limited thereto.

Understandably, the second tab 50 and the third tab 60 may also be positioned in a multi-layer stacked structure, and the disposition manner is similar to that of the first tab 40 and is omitted herein.

### Eighth Embodiment

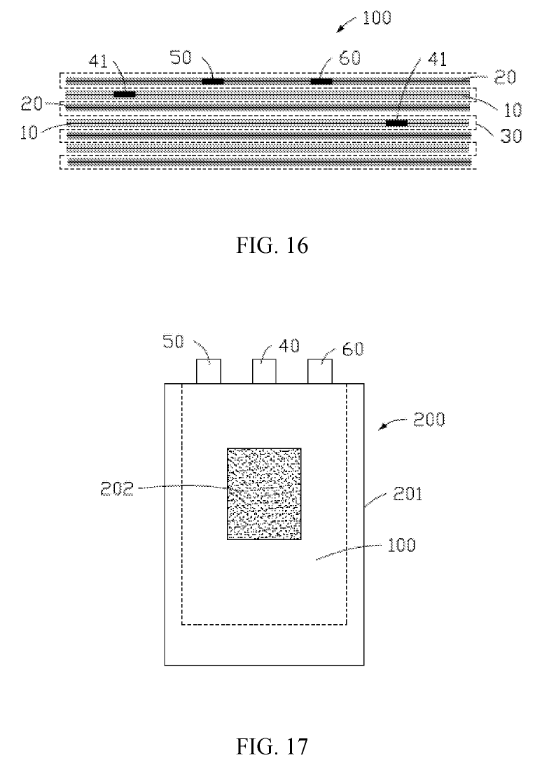

Referring to FIG. 16, an electrode assembly 100 in an eighth embodiment is almost identical to that in the seventh embodiment, but differs in: in the eighth embodiment, along the thickness direction of the electrode assembly 100, projections of the first tab units 41 on two adjacent first electrode plates 10 do not overlap. In other words, in the thickness direction of the electrode assembly 100, a projection of a first tab unit 41 positioned on an n^{th} first electrode plate 10 and projected on the first electrode plate 10 overlaps a projection of a first tab unit 41 positioned on an (n+2)^{th} first electrode plate 10.

For example, from a perspective shown in FIG. 16, the first tab unit 41 on a first-layer first electrode plate 10 is positioned to the left, the first tab unit 41 on a second-layer first electrode plate 10 is positioned to the right, the first tab unit 41 on a third-layer first electrode plate 10 is positioned farther to the left and aligned with the first tab unit 41 on the first-layer first electrode plate 10, the first tab unit 41 on a fourth-layer first electrode plate 10 is positioned farther to the right and aligned with the first tab unit 41 on the second-layer first electrode plate 10, and so on. This disposition manner can increase a spacing between adjacent first tab units 41, and help improve heat dissipation performance of the first tab 40.

### Ninth Embodiment

Referring to FIG. 17, a ninth embodiment provides a battery 200, including a package 201 and an electrode assembly 100 disclosed in any of the foregoing embodiments. The electrode assembly 100 is positioned in the package 201. The first tab 40, the second tab 50, and the third tab 60 extend out of the package 201. The seal 103 is located at a junction between the package 201 and each of the first tab 40, the second tab 50, and the third tab 60 to fill a gap between the package 201 and each of the first tab 40, the second tab 50, and the third tab 60, and to prevent an electrolytic solution, chemical slurry, and the like from flowing out of the package 201.

Furthermore, the battery 200 includes a connecting piece 202. The connecting piece 202 is positioned on an outer surface of the electrode assembly 100 and configured to connect the package 201 and the electrode assembly 100. The connecting piece 202 may be double-sided adhesive tape or hot-melt adhesive affixed to the outer surface of the electrode assembly 100.

The foregoing embodiments are merely intended for describing the technical solutions of this application but not intended as a limitation. Although this application is described in detail with reference to the foregoing optional embodiments, a person of ordinary skill in the art understands that modifications or equivalent substitutions may be made to the technical solutions of this application without departing from the spirit and scope of the technical solutions of this application.

What is claimed is:

1. A battery, comprising an electrode assembly and a package accommodating the electrode assembly; wherein the electrode assembly comprises:
a first electrode plate; and
a second electrode plate, wherein a polarity of the second electrode plate is opposite to a polarity of the first electrode plate; wherein
the battery further comprises a first tab, a second tab, and a third tab; the first tab is electrically connected to the first electrode plate, and the second tab and the third tab are electrically connected to the second electrode plate; the first tab, the second tab, and the third tab are disposed at the same side of the electrode assembly and extend out of the package in a first direction; in a second direction, a projection of the first tab, a projection of the second tab, and a projection of the third tab on the first electrode plate do not overlap;
the battery further comprises a first seal, a second seal, and a third seal; the first seal is positioned at a junction between the first tab and the package in the second direction, the second seal is positioned at a junction between the second tab and the package in the second direction, and the third tab is positioned at a junction between the third tab and the package in a third direction; two sides of the first seal exceed two sides of the first tab in the third direction, two sides of the second seal exceed two sides of the second tab in the third direction, and two sides of the third seal exceed two sides of the third tab in the third direction; a spacing between adjacent seals of the first seal, the second seal, and the third seal in the third direction is at least 1 mm; the second direction is a thickness direction of the electrode assembly, and the first direction, the second direction, and the third direction are perpendicular to each other; and
the battery further comprises a connecting piece disposed on an outer surface of the electrode assembly in the second direction, and the connecting piece binds the electrode assembly to the package.

2. The battery as claimed in claim 1, wherein the second electrode plate comprises a first electrode plate unit and a second electrode plate unit, the first electrode plate is positioned between the first electrode plate unit and the second electrode plate unit, the second tab is electrically connected to the first electrode plate unit, and the third tab is electrically connected to the second electrode plate unit.

3. The battery as claimed in claim 2, wherein the second tab and the third tab are electrically connected to a same first electrode plate unit or a same second electrode plate unit.

4. The battery as claimed in claim 1, wherein, in the second direction, a projection of the first tab electrically connected to the first electrode plate is located between a projection of the second tab electrically connected to the first electrode plate and a projection of the third tab electrically connected to the first electrode plate.

5. The battery as claimed in claim 1, wherein, the electrode assembly is a laminated structure.

6. The battery as claimed in claim 1, wherein the first tab comprises a plurality of first tab units, the electrode assembly comprises a plurality of the first electrode plates, and the plurality of first tab units are electrically connected to the plurality of the first electrode plates respectively; and the plurality of first tab units are stacked in the second direction to form a part of the first tab.

7. The battery as claimed in claim 6, wherein a fastener is positioned between the plurality of first tab units, and the fastener connects the plurality of first tab units to form the part of the first tab.

8. The battery as claimed in claim 6, wherein each of the first tab units and each of the first electrode plates are integrally formed.

9. The battery as claimed in claim 5, wherein, in the second direction, projections of the first tab units positioned on alternate first electrode plates overlap.

10. The battery as claimed in claim 1, wherein the second tab and the third tab are configured to connect an external circuit separately.

11. The battery as claimed in claim 1, wherein the electrode assembly further comprises a fourth tab, the fourth tab is electrically connected to the first electrode plate or the second electrode plate, and the fourth tab extends out of the package; in the second direction, a projection of the fourth tab does not overlap the projections of the first tab, the second tab, and the third tab.

12. The battery as claimed in claim 1, wherein, the first electrode plate is a negative electrode plate, and a material of the first tab is nickel-plated copper.

13. The battery as claimed in claim 1, wherein the second electrode plate is a negative electrode plate, and a material of the second tab and/or a material of the third tab is nickel-plated copper.

14. The battery as claimed in claim 1, wherein the seal is a sealant, a double-sided adhesive tape, or a hot-melt adhesive.

15. The battery as claimed in claim 1, wherein the connecting piece is a double-sided adhesive tape or a hot-melt adhesive.

16. The battery as claimed in claim 1, wherein in the third direction, the first tab is positioned between the second tab and the third tab; viewed from the first direction, a projection of the first tab on the outer surface of the electrode assembly overlaps with a projection of the connecting piece on the outer surface of the electrode assembly.

17. The battery as claimed in claim 1, wherein in the third direction, the second tab is positioned between the first tab and the third tab; viewed from the first direction, a projection of the second tab on the outer surface of the electrode assembly overlaps with a projection of the connecting piece on the outer surface of the electrode assembly.

18. The battery as claimed in claim 1, wherein the number of the connecting piece disposed on the outer surface of the electrode assembly is one.

19. The battery as claimed in claim 1, wherein a corner of the second electrode plate at the side the second tab positioned is a chamfer structure, and the second tab is a closest tab to the chamfer structure in the third direction; viewed from the first direction, the second seal is spaced apart from the chamfer structure in the third direction.

20. An electronic product, comprising a battery, the battery comprising an electrode assembly and a package accommodating the electrode assembly; wherein the electrode assembly comprises:
a first electrode plate; and
a second electrode plate, wherein a polarity of the second electrode plate is opposite to a polarity of the first electrode plate; wherein
the battery further comprises a first tab, a second tab, and a third tab; the first tab is electrically connected to the first electrode plate, and the second tab and the third tab are electrically connected to the second electrode plate; the first tab, the second tab, and the third tab are disposed at the same side of the electrode assembly and extend out of the package in a first direction; in a second direction, a projection of the first tab, a projection of the second tab, and a projection of the third tab on the first electrode plate do not overlap;
the battery further comprises a first seal, a second seal, and a third seal; the first seal is positioned at a junction between the first tab and the package in the second direction, the second seal is positioned at a junction between the second tab and the package in the second direction, and the third tab is positioned at a junction between the third tab and the package in a third direction; two sides of the first seal exceed two sides of the first tab in the third direction, two sides of the second seal exceed two sides of the second tab in the third direction, and two sides of the third seal exceed two sides of the third tab in the third direction; a spacing between adjacent seals of the first seal, the second seal, and the third seal in the third direction is at least 1 mm; the second direction is a thickness direction of the electrode assembly, and the first direction, the second direction, and the third direction are perpendicular to each other; and
the battery further comprises a connecting piece disposed on an outer surface of the electrode assembly in the second direction, and the connecting piece binds the electrode assembly to the package.
